(19) United States
(12) Patent Application Publication
(10) Pub. No.: US 2005/0058798 A1
(43) Pub. Date: Mar. 17, 2005

(54) Assembly tape with slits and folds

(76) Inventors: Marco Sieber, Horw (CH); Reto Sieber, Sigigen (CH)

Correspondence Address: JORDAN AND HAMBURG LLP, 122 EAST 42ND STREET, SUITE 4000, NEW YORK, NY, 10168, US

(21) Appl. No.: 10/889,758

(22) Filed: Jul. 13, 2004

(30) Foreign Application Priority Data
Aug. 18, 2003 (DE) 103 37 880.4

(51) Int. Cl. B32B 9/00

(52) U.S. Cl. 428/40.1; 428/124

(57) ABSTRACT

The invention relates to a pressure-sensitive tape for closing, sealing, and gluing joints, in particular in housing construction, and in particular joints in corners and edges, that has a backing on the tape top side, an adhesive coating of the backing on the tape bottom side, and a removable protective film on the tape bottom side, whereby the protective film has at least one first slit. At least one first fold section of the tape is folded in the transverse direction along a first fold edge that runs in the longitudinal direction of the tape, whereby the first slit runs at a different location than the first fold edge.

The invention relates to a pressure-sensitive tape for closing, sealing, and gluing joints, in particular in housing construction, and in particular joints in corners and edges, a so-called assembly tape, with a backing on the tape top side, an adhesive coating of the backing on the tape bottom side, and a removable protective film on the tape bottom side.

In general such adhesive tapes are used in housing construction when for instance different structural elements, such as doors or windows, are to be inserted into a wall opening and the joint that occurs between the structural elements and the corresponding wall opening must be closed, which must especially occur when installing such structural elements in the exterior walls of buildings in order to attain appropriate sealing.

One general problem of such pressure-sensitive tapes is attaining a good seal, with the least complicated usage possible, by correctly applying such tapes in areas that are difficult to access in order that the joints are closed as air-tight and moisture-tight as possible.

German Patent DE 101 35 799 A1 from the same applicant indicates an assembly tape for improved joint sealing with a suitable assembly tape dispenser, whereby the corresponding assembly tape has on the tape bottom side an adhesive layer provided on a backing on a tape top side, which adhesive layer is provided with a removable protective film on the tape bottom side. The protective film has a slit running in the longitudinal direction and the tape is folded once upon itself in the transverse direction along this slit such that at least a portion of the protective film is disposed on the exterior, that is, on the tape top side. Furthermore, this tape has at least one lateral longitudinal section that is perforated. A special assembly tape dispenser for receiving and dispensing the assembly tape is provided in order to be able to securely handle the rolled-up adhesive assembly tape, which during transport and use slips out of place relatively easily due to the protective film. The single fold in the adhesive assembly tape along a slit in the protective film permits the known adhesive assembly tape to be applied effectively, even in areas that are difficult to access. Although the simple fold along a slit provides reliable processability, during processing the protective film must first be removed along the slit of the fold edge prior to actually applying the cited adhesive assembly tape. Also, in certain applications, especially in very spatially constrained circumstances, it can be desirable to optimize ease of use even further.

The object of the invention is to provide a pressure-sensitive tape for closing, sealing, and gluing joints, in particular in housing construction, and in particular joints in corners and edges, that overcomes the disadvantages of the prior art and in particular, despite simple and thus cost-effective design, provides optimum sealing while simultaneously further improving ease of use, in particular in difficult and/or spatially constrained circumstances.

This object is attained with a pressure-sensitive tape in accordance with claim 1.

Advantageous embodiments and further developments are defined in the subordinate claims.

The inventive pressure-sensitive tape for closing, sealing, and gluing joints, in particular in housing construction, and in particular joints in corners and edges, which are particularly difficult to reach, has a backing on the tape top side, an adhesive coating of the backing on the tape bottom side, and a removable protective film on the tape bottom side, whereby the protective film has at least one first slit. In accordance with the invention, at least one first fold section of the tape is folded in the transverse direction along a first fold edge that runs in the longitudinal direction of the tape, whereby this first fold edge runs at a different location than the first slit.

The inventive combination of a fold in the tape along a first fold edge and a first slit that runs at a different location than the first fold edge results under certain conditions in further improved processability of the tape. Prefolding can simplify affixing the tape in corners and at edges, while the slit provides the option of removing the protective film from the adhesive coating in sections and affixing the tape at such an adhesive section for instance to a window frame that is to be sealed. Because the slit and the folding edge do not coincide, there is the advantage that only the area of the inventive tape that is to be securely glued must be removed from a corresponding section of the protective film, while the folding edge runs at a distance from the adhesive section. This offers advantages especially when built-in elements go around a corner and the corner runs at a different location than the area of the structural element to which the tape is to be glued. In such special geometric configurations, the appropriately inventively designed pressure-sensitive adhesive tape thus offers the advantage of further improved processability, which also ensures that the tape is securely affixed and thus seals in all circumstances. Such an inventive tape can be employed for instance in dry construction and/or in concrete-poured construction. Thus, at sites that are spatially very difficult to access, such as 90° corners, for instance between two adjoining dry construction walls, or in the area of a window, where the inventive tape can be applied with the greatest possible precision to the window frame, the risk is avoided that during a subsequent plastering process the tape will be cut through by a blow from a plastering tool and thus its air-tightness will be lost. The pre-fold saves the user much time, in particular when larger window surfaces with a plurality of inserted window frames are to be installed in the exterior walls of a new construction house. Otherwise this folding would have to be done manually—in accordance with the invention this is not necessary. If the inventive adhesive tape is employed in wooden construction, it is sufficient to apply just individual sections or edge sections of the sealing tape because of the narrower joint widths that occur between mutually adjacent structural elements, so that appropriate inventive arrangement of a suitable slit or slits makes possible very precise and rapid processability of the inventive tape.

Preferred is one embodiment of the invention in which the tape has a second fold section that is folded in the transverse direction along a second fold edge that runs in the longitudinal direction of the tape. This second fold section makes it possible for instance to use an appropriately designed adhesive tape in a simple manner in an application between a plurality of U profiles.

Preferably the protective film of the inventive tape can have at least one second slit in the longitudinal direction of the tape. This results in at least one more opportunity to remove the protective film appropriately by section from the tape bottom side, i.e. from the adhesive coating on the tape bottom side. Thus there is the option of providing two adhesive sections, one section of the advantageously designed inventive tape remaining covered with the protective film, for instance a central area that is situated between the structural element and the actual wall.

In accordance with another preferred embodiment of the invention, the second fold edge coincides with the second slit in the protective film. This provides the option of removing the protective film of the adhesive coating from the second fold section and gluing the corresponding assembly tape in the area of the second fold section.

However, in accordance with another preferred embodiment, it is also possible that the second fold edge does not coincide with the first slit and or the second slit in the protective film. This results in a flexible configuration option in which the protective film does not necessarily have to be removed from the entire second fold section along the first slit and/or along the second slit. Thus it is possible to adapt individually to various circumstances, whereby in particular just one part of the second fold section permits the protective film there to be removed via a corresponding slit.

The same applies for the embodiment of the invention in which preferably the first fold edge does not coincide with the second slit in the protective film.

Non-coincident fold edge(s) and slit(s) can preferably be separated from each neighbor by a distance of approximately 1 mm to 25 cm.

In accordance with one preferred embodiment of the invention, one edge section of the protective film projects over the first fold edge and/or the second fold edge. In this manner, one or two grip section(s) result(s) that facilitate(s) removing the protective film in a simple manner by grasping this edge section. This further improves ease of use of the inventive pressure-sensitive film. The section/sections can preferably have a width of approximately 1 mm to 1 cm.

Depending on the individual application, different arrangements of the fold sections can be particularly advantageous for processability.

In accordance with one preferred embodiment of the invention, the first fold section and the second fold section can be mutually opposing edge sections of the inventive tape; however, it is also possible in accordance with another preferred embodiment of the invention that the first fold section and the second fold section are adjacent to one another as seen in the transverse direction of the tape. In accordance with another preferred embodiment, the first fold section and the second fold section lie at least partially one upon the other when the tape is folded.

In accordance with another preferred embodiment of the invention, tape bottom side can lie upon tape bottom side in the area of the first fold section and/or in the area of the second fold section; however, in accordance with another preferred embodiment, it is also possible that tape top side lies upon tape top side in the area of the first fold section and/or in the area of the second fold section.

Particularly advantageous is one embodiment of the invention in which at least one part of the adhesive coating is not covered with the protective film. This protective film does not first have to be tediously removed along the portion of the adhesive coating of the inventive tape that is not covered with the protective film, which results in more rapid processability of the inventive tape. This also prevents any folds or waste caused by the required removal of the film from occurring in tape that has been applied. Also, such an inventively designed tape does not require an additional assembly tape dispenser for receiving and dispensing the tape, because the inventive tape in accordance with this preferred embodiment does not displace when folded or rolled due to the adhesive coating that remains partially free of protective film. The inventive tape is thus especially simple and reliable to use. The tape can also thus be transported to the usage sites or construction sites without the user having to take special packaging or protective measures.

In accordance with one preferred embodiment of the invention, the adhesive coating of the tape is not covered with the protective film at least in the area of the first fold section and/or in the area of the second fold section. That is, the folded area or areas of the inventive tape preferably does not/do not carry any protective film. Thus, in spatially constrained circumstances, for instance in edges or U-profiles, this/these area/areas can be unrolled directly from the roll and applied without supplementary aids or steps, such as for instance removing the protective film or tedious folding, whereby reliable sealing results with further simplified processability. This simple form of processing saves up to half of the work time compared to using tapes from prior art.

Preferably the width of the first and/or second fold section or the width of the fold sections can be narrower than the width of the tape area that is not folded. Preferably the width of the first and/or second fold section or the width of the fold sections can also be the same width or largely the same width as the width of the tape section that is not folded. Preferably the width of the first and/or second fold section or the width of the fold sections can also be greater than the width of the tape section that is not folded. The width of the first and/or second fold section or the width of the fold sections can preferably be at least 3 mm, more preferably at least 8 mm, even more preferably at least 12 mm, and/or further preferably can equal the width of the tape section that is not folded and/or can even more preferably be greater than the width of the tape section that is not folded.

In order to ensure secure adhesion of the inventive pressure-sensitive tape to a wide variety of materials, even under adverse conditions (cold, moisture), and in order attain the most reliable possible sealing of the inventive pressure-sensitive tape under all circumstances, in accordance with one preferred embodiment the backing comprises a material made from the group of paper, plastic, woven textile, and non-woven textile, or a combination of at least two of these materials, and the adhesive coating comprises at least one material from the group of pressure-sensitive acrylate adhesives, rubber adhesives, butyl adhesives, hot melt, or a combination of at least two of these adhesives.

In accordance with one preferred embodiment, the processability of the inventive tape is particularly improved when the tape is constituted such that at least its backing can be torn manually transverse to the longitudinal direction of the tape. Preferably the protective film can also be torn manually transverse to the longitudinal direction of the tape. Thus it is possible in a simple manner to break the tape into sections without using tools while it is being placed.

In accordance with one preferred embodiment, if the adhesive coating of the inventive tape has a non-adhesive center strip, this makes it even easier in particular to glue joints between two structural elements that are at right angles to one another, since out-of-true gluing with creasing is prevented in a simple manner in the area where these two structural elements meet. The sealing effect is completely retained, since the two edge areas of the tape can be glued.

Particularly easy to use is the inventive pressure-sensitive tape in accordance with one preferred embodiment, in which the tape is rolled up in its folded state into a roll of adhesive tape. This roll is particularly easy to use on site during application, even without an additional dispenser.

In accordance with one preferred embodiment of the inventive tape, provided at least at the side of the first fold edge of the roll is an intermediate layer, which prevents sticking in the area of the first fold edge prior to the actual application of the tape. In the area of the first fold edge, the intermediate layer reliably covers any adhesive coating that is exposed so that it is also possible to reliably prevent soiling particles from accumulating before the tape is even applied. The processability of the thus advantageously designed inventive tape is further improved in this manner.

Preferably the inventive tape has a width of at least 3 cm in the non-folded state, more preferably a width in the range of 3 cm to 50 cm, even more preferably a width in the range of 4 cm to 30 cm, and most preferably a width in the range of 4.5 cm to 20 cm. These dimensions permit somewhat wider joints to be securely sealed, as well, and also prevent the inventive tape from becoming difficult to use due to excessive width so that creases form and there are leaks when the inventive tape is placed.

In accordance with another preferred embodiment of the invention, the tape has at least one perforation area with perforation apertures whose average diameter is at least 3 mm. With such a pressure-sensitive tape it can be assured for instance that the at least one perforation area of the tape can be plastered over, resulting in particularly good anchoring, without jeopardizing the sealing effect of the tape. Advantageously, the at least one perforation area can be embodied on one edge area of the tape; however, it is also possible to provide both edge areas of the tape with a corresponding perforation area. In particular, the corresponding edge areas, which can be embodied as perforation areas, can also correspond to the corresponding first and second fold sections of the tape. At least the center strip of the tape, which should preferably not be perforated, should however be wider than the maximum width of the joint to be sealed, depending on application, in order to ensure optimum sealing. Since the perforated longitudinal section of the inventive tape in accordance with one preferred embodiment is disposed on one edge area of the tape and the center strip remains unperforated, a situation is prevented in which the perforation apertures lead to leaks when the joint to be sealed is covered with the appropriately designed pressure-sensitive tape.

In accordance with another advantageous embodiment of the invention, the backing, the adhesive coating, and the removable protective film are perforated with corresponding continuous perforation apertures. Such perforation apertures can be particularly simply and inexpensively produced using corresponding punches, which leads to favorable manufacturing costs. In general the protective film and/or the backing prevent a perforating tool from coming into contact with the adhesive layer of the pressure-sensitive tape. However, in general it is also possible that the adhesive tape be provided with perforation apertures in the area that is not covered with the protective film.

The perforation apertures can preferably be embodied largely round, polygonal, or oval.

In accordance with another preferred embodiment of the invention, the backing can comprise a material, in particular an open-pore material that has good adhesive properties for plastering. The adhesive effect of the tape on the plaster background is thus additionally improved and the parts of the plastering are thus prevented from detaching from the tape designed in this manner.

The invention is described in detail in the following using exemplary embodiments of the invention in the drawings.

FIG. 1 illustrates sectional view of a first embodiment of an inventive tape in the transverse direction of the tape.

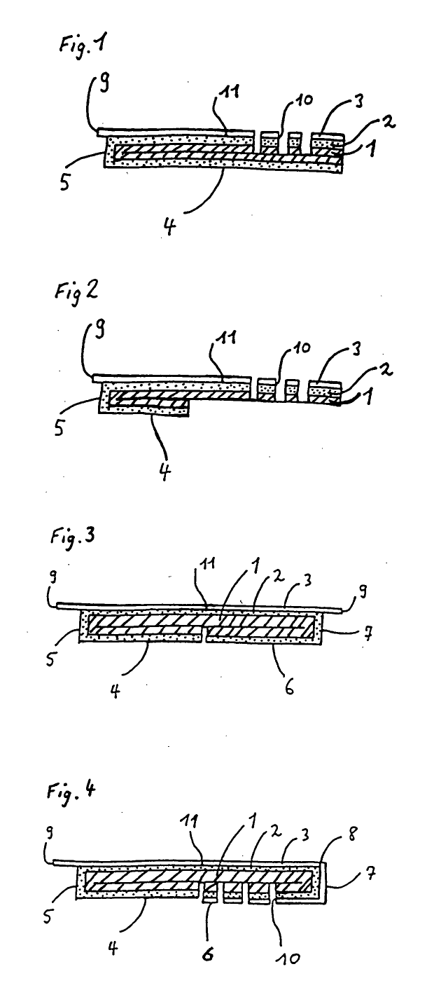

FIG. 2 illustrates a second sectional view of a preferred embodiment of the inventive tape in the transverse direction of the tape.

FIG. 3 illustrates a third sectional view of a preferred embodiment of the inventive tape in the transverse direction of the tape.

FIG. 4 illustrates a fourth sectional view of a preferred embodiment of the inventive tape in the transverse direction of the tape.

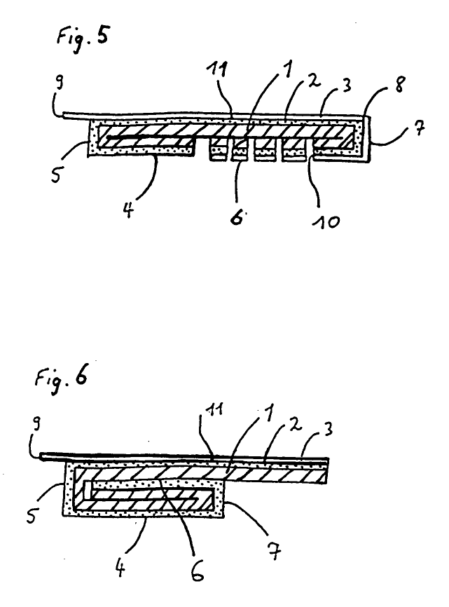

FIG. 5 illustrates a fifth sectional view of a preferred embodiment of the inventive tape in the transverse direction of the tape.

FIG. 6 illustrates a sixth sectional view of a preferred embodiment of the inventive tape in the transverse direction of the tape.

FIG. 1 illustrates a schematic sectional view of one preferred embodiment of a pressure-sensitive tape in accordance with the invention along the transverse direction of the tape. The inventive tape in accordance with FIG. 1 has a backing 1 on a tape top side, an adhesive coating 2 of the backing 1 on the tape bottom side, and a removable protective film 3 on the tape bottom side. A first fold section 4 of the tape is folded over once in the transverse direction along a first fold edge 5 that runs in the longitudinal direction of the tape and a portion of the adhesive coating 2 is not covered with the protective film 3 along a longitudinal section of the tape. The tape thus comes to rest upon itself at least in the folded area, that is, it is folded upon itself. In accordance with FIG. 1, the portion of the adhesive coating 2 that is not covered with the protective film 3 corresponds to the area of the first fold section 4. A first slit 11 of the protective film 3 is provided in the longitudinal direction of the tape, whereby this first slit 11 does not coincide with the first fold edge 5, but in accordance with FIG. 1 is largely present centrally on the top side of the folded tape in accordance with the invention. An edge section 9 of the protective film 3 projects over the first fold edge 5 and thus acts as a grip section for removing the protective film 3.

Furthermore, provided in the non-folded area of the inventive tape illustrated in FIG. 1 are perforation apertures 10 that extend in one edge area of the tape through the backing 1, the adhesive coating 2, and the removable protective film 3.

In general it should be noted that the rendering in FIG. 1, and the other renderings, are not to scale and merely provide a schematic illustration of the structure and design of embodiments of the inventive tape. In particular the thicknesses of the individual layers are not provided to scale. In general the inventive tape preferably has a width of at least 3 cm when not folded. The perforation apertures 10 have an average diameter of at least 3 mm.

In accordance with the embodiment illustrated in FIG. 1, the inventive tape is folded upon itself such that the first fold section 4 has the same width as the non-folded section of the inventive tape that is arranged thereabove in FIG. 1.

FIG. 2 illustrates a schematic sectional view of a second embodiment of the invention along the transverse direction of the inventive tape. In FIG. 2, as in the other figures, the same reference numbers indicate identical elements in the invention. The embodiment of the invention illustrated in FIG. 2 largely corresponds to the embodiment of the invention illustrated in FIG. 1, with the difference that the first fold section 4 does not have the same width as the non-folded section. In the embodiment illustrated in FIG. 2, the first fold section 4 has a width that is equal to approximately one-third of the width of the non-folded section or area of the inventive tape that is arranged thereabove in FIG. 2.

FIG. 3 illustrates another embodiment of the invention in a schematic sectional view along the transverse direction of the inventive tape. In FIG. 3, as in the other figures, the same reference numbers indicate identical elements in the invention.

In FIG. 3, an embodiment of the invention is illustrated in which a first fold section 4 of the tape is folded in the transverse direction along a first fold edge 5 that runs in the longitudinal direction of the tape and a second fold section 6 is folded in the transverse direction along a second fold edge 7 that runs in the longitudinal direction of the tape. Both fold sections are thus longitudinal sections of the tape that are not covered with the protective film 3. Both the first fold section 4 and the second fold section 6 are edge sections of the tape that are selected in terms of their dimensions such that together they approximately correspond to the width of the remaining non-folded pressure-sensitive tape in accordance with the invention. As edge areas of the inventive tape, both the first fold section and the second fold section therefore have a width that is essentially one-quarter of the total width of the tape in its unfolded state. The protective film 3 of the tape has two edge sections 9 of the protective film 3; these project over the first fold edge 5 and the second fold edge 7, respectively. Thus grip sections are formed that make it possible to remove the protective film 3. A first slit 11 is provided that coincides neither with the first fold edge 5 nor with the second fold edge 7. The first slit 11 is inventively arranged approximately in the center of the tape in the folded state; however, in general it can be disposed at any other position in a suitable manner depending on the specific product design.

FIG. 4 schematically illustrates a sectional view of a fourth embodiment of the inventive tape. The embodiment in accordance with FIG. 4 largely corresponds to the embodiment in accordance with FIG. 3. The difference is that in accordance with FIG. 4 the protective film 3 also covers the area of the second fold section 6 and the adhesive coating 2 there. Furthermore, in the area of the second fold section 6 the tape has the perforation apertures 10 described in the context of FIG. 1. Additionally provided is a second slit 8 of the protective film 3, which runs in the longitudinal direction of the tape and in accordance with the embodiment illustrated in FIG. 4 coincides with the second fold edge 7. Thus the protective film 3 can be removed along the slit 8 in the area of the second film section 6. The other elements of the tape illustrated in FIG. 4 correspond to the elements that have already been described in the other figures.

FIG. 5 illustrates a fifth embodiment of the invention in a sectional schematic view along the transverse direction of the inventive tape. In FIG. 5, as in the other figures, the same reference numbers indicate identical elements in the invention. The embodiment of the invention illustrated in FIG. 5 largely corresponds to the embodiment of the invention illustrated in FIG. 4, with the difference that the first fold section 4 and the second fold section 6 do not have the same width, which essentially corresponds to one-quarter of the total width of the tape in its unfolded state. In the embodiment illustrated in FIG. 5, relative to the width of the second fold section 6, the first fold section 4 has a narrower width, which is preferably equal to approximately one-half the width of the second fold section 6. The other elements of the tape illustrated in FIG. 5 correspond to the elements that have already been described for FIG. 4.

FIG. 6 illustrates another preferred embodiment of the inventive tape in a schematic sectional representation in the transverse direction of the tape.

FIG. 6 also illustrates an embodiment of the inventive tape in which both a first fold section 4 and a second fold section 6 are provided. Differing from the embodiments of the invention illustrated in FIGS. 3, 4, and 5, however, the first fold section 4 and the second fold section 6 are not opposing end sections of the tape, but rather the first fold section 4 and the second fold section 6 abut one another seen in the transverse direction of the tape. Furthermore, the second fold section 6 is folded upon the first fold section 4 such that they lie one upon the other. In accordance with FIG. 6, both the first fold section 4 and the second fold section 6 have no protective film 3 covering the adhesive coating 2. As in the other illustrated embodiments of the invention, the protective film 3 of the inventive tape has a first slit 11 that does not coincide with the first fold edge 5 and also does not coincide with the second fold edge 7.

1. Pressure-sensitive tape for closing, sealing, and gluing construction joints, said tape comprising:
a bottom side and a top side;
a backing on said tape top side, said backing having a top side and a bottom side;
an adhesive coating, said adhesive coating having a top side and a bottom side, said adhesive coating being located against said backing bottom side;
a removable protective film, said protective film being on said tape bottom side, said protective film having a first slit; and
a first transverse fold section, said fold section longitudinally extending along said tape.

2. The tape in accordance with claim 1, further comprising a second transverse fold section, said second transverse fold section extending longitudinally along said tape.

3. The tape in accordance with claim 2, further comprising a second slit, said second slit extending longitudinally along said protective film.

4. The tape in accordance with claim 3, wherein said second fold edge coincides with said protective film second slit.

5. The tape in accordance with claim 3, wherein said second fold edge is offset from said protective film first slit.

6. The tape in accordance with claim 3, wherein said first fold edge is offset from said protective film second slit.

7. The tape in accordance with claim 6, wherein said protective film has an edge section, said edge section being adjacent to said first fold edge.

8. The tape in accordance with claim 7, wherein said first fold section opposes said second fold section.

9. The tape in accordance with claim 8, wherein said first fold section is transversely adjacent to said second fold section.

10. The tape in accordance with claim 9, wherein said first fold section partially contacts said second fold section.

11. The tape in accordance with claim 10, wherein said tape bottom is located adjacent to said first fold section.

12. The tape in accordance with claim 10, wherein said tape top side is located adjacent to said first fold section.

13. The tape in accordance with claim 12, wherein said adhesive coating is partially uncovered by said protective film.

14. The tape in accordance with claim 13, wherein said adhesive coating is uncovered by said protective film adjacent to said first fold section.

15. The tape in accordance with claim 14, wherein said backing comprises one or more of paper, plastic, woven textile, and non-woven textile, and said adhesive coating comprises one or more of pressure-sensitive acrylate adhesives, rubber adhesives, butyl adhesives, and hot melt.

16. The tape in accordance with claim 15, wherein said backing is adapted for longitudinal tearing.

17. The tape in accordance with claim 16, wherein said adhesive coating has a non-adhesive center strip.

18. The tape in accordance with claim 17, wherein said tape is rolled for forming roll of adhesive tape.

19. The tape in accordance with claim 18, further comprising an intermediate layer, said intermediate layer being provided adjacent to said first fold edge of said roll of adhesive tape.

20. The tape in accordance with claim 19, wherein said tap has a width of at least 3 cm.

21. The tape in accordance with claim 20, wherein said tape further comprises a perforation area, said perforation area having perforation apertures with an average diameter of at least 3 millimeters.

22. The tape in accordance with claim 22, wherein said perforation aperture penetrate said backing, said adhesive coating, and said removable protective film.

23. The tape in accordance with claim 22, wherein said perforation apertures round, polygonal, or oval.

24. The tape in accordance with claim 23, wherein said backing comprises an adhesive open-pore material adapted for plastering.

25. The tape in accordance with claim 3, wherein said second fold edge is offset from said protective film first slit and said protective film second slit.

26. The tape in accordance with claim 6, wherein said protective film has an edge section, said edge section being adjacent to said first fold edge and said second fold edge.

27. The tape in accordance with claim 10, wherein said tape bottom is located adjacent to said first fold section and said second fold section.

28. The tape in accordance with claim 10, wherein said tape top side is located adjacent to said first fold section and said second fold section.

29. The tape in accordance with claim 13, wherein said adhesive coating is uncovered by said protective film adjacent to said first fold section and said second fold section.

30. The tape in accordance with claim 19, wherein said tape has a width of between 3 cm and 50 cm.

31. The tape in accordance with claim 19, wherein said tape has a width of between 4.5 cm and 20 cm.
